(19) United States
(12) Patent Application Publication
(10) Pub. No.: US 2004/0154421 A1
(43) Pub. Date: Aug. 12, 2004

(54) Ball screw-nut device

(76) Inventor: Jean- Francois Pfister, Sonceboz (CH)

Correspondence Address: Clifford W Browning, Woodard Emhardt Naughton Moriarty & McNett, Bank One Center Tower, 111 Monument Circle Suite 3700, Indianapolis, IN, 46204-5137, US

(21) Appl. No.: 10/482,859

(22) PCT Filed: Jul. 5, 2002
(86) PCT No.: PCT/IB02/02664

(30) Foreign Application Priority Data
Jul. 13, 2001 (EP) 01810700.3

(51) Int. Cl. F16H 25/22

(52) U.S. Cl. 74/424.82; 74/424.86

(57) ABSTRACT

The invention concerns a ball screw-nut device comprising a screw (2) and a nut (3), the nut including a housing (7) and a ball-bearing element (4) comprising a raceway (13) and a plurality of balls (15), the ball-bearing element (4) being produced as an independent part which assembled with the housing.

The present invention relates to a ball screw-nut device.

In conventional ball screw-nut devices, the nut is generally made of metal and the ball bearing rails are manufactured, in particular, by way of removing material, which is relatively costly. Furthermore, in certain applications, the high inertia of the metal nut is a disadvantage.

It would be advantageous to decrease the cost of manufacturing ball screw-nut devices. For certain applications, it would be advantageous to reduce the weight of the nut. For certain applications, it would be advantageous to reduce the size of the nut.

An objective of the invention is to provide a ball screw-nut device, which is efficient, reliable and inexpensive.

It is advantageous to provide a ball screw-nut device, which is adapted to mass production, in particular by avoiding operations of removing material or other expensive machining methods.

It is, furthermore, advantageous to provide a screw-nut device, wherein the material of the nut can be selected from a broader range, so as to enable a choice adapted to a particular application, for instance to enable a decrease of the weight of the nut or to allow a greater choice in the design of the shape.

It is, furthermore, advantageous to provide a ball screw-nut device with a compact shape.

Such objectives of the invention have been achieved with a ball screw-nut device according to claim 1.

Such objectives of the invention have also been achieved with a ball screw-nut device according to claim 10.

According to one aspect of the present invention, a ball screw-nut device comprises a screw and a nut, with the nut including a housing and a ball bearing device comprising a ball bearing rail and a plurality of balls, and with the ball bearing device being manufactured as an independent part, which is assembled with the housing.

Advantageously, this construction makes it possible to reduce the manufacturing costs and to widen the range of materials which can be selected for the housing of the nut, while guaranteeing the reliability of the device. For instance, the relatively costly machining method used for forming the ball bearing rail through the removal of material can be replaced by a method comprising separately manufacturing the housing and the ball bearing rail and subsequently assembling them.

According to another aspect of the present invention, the ball screw-nut device comprises a screw and a nut, with the nut comprising a housing and a ball bearing device comprising a ball bearing rail, a plurality of balls and a ball recirculation rail, whereby the ball bearing rail and the ball recirculation rail form together a rail having, substantially, the shape of an “8”.

The housing includes at least a first housing part and a second housing part, which are fastened together, with the ball bearing device being placed at an interface between the two parts of the housing. Advantageously, the positioning of the ball bearing device at the interface between the two parts of the housing enables an easy and an automated assembling of the constituent parts and contributes consequently to reducing costs.

The housing can be manufactured from a plastic material, which makes it possible to reduce the weight of the device and to provide for a measure of flexibility as to its shape, thus enabling a broad range of uses.

Advantageously, this construction makes it possible to provide a screw—nut device, which is very compact, in particular in the axial direction.

The ball bearing rail is preferably formed by a stamping operation from a metal sheet and can be hardened by a quenching operation. Advantageously, the use of a metal sheet for making the ball bearing rail through a drawing operation makes possible a mass-production at a low cost, while guaranteeing a sufficient resistance of the ball bearing rail against the pressure exerted by the balls.

The ball bearing rail can be made from, at least, two supporting wall parts, which are substantially identically shaped, which makes it possible to decrease the number of the different parts which need to be manufactured. The ball bearing rail can be formed, substantially, inthe shape of a spire.

The ball bearing device includes, furthermore, a ball recirculation rail arranged in such a manner as to enable the recirculation of the balls to the ball bearing rail. The ball recirculation rail can be advantageously shaped as a spire, which makes it possible to recirculate the balls in a reliable manner and in a small volume.

Other advantageous objects and aspects of the invention will become apparent from the claims, from the description and from the appended drawings, in which

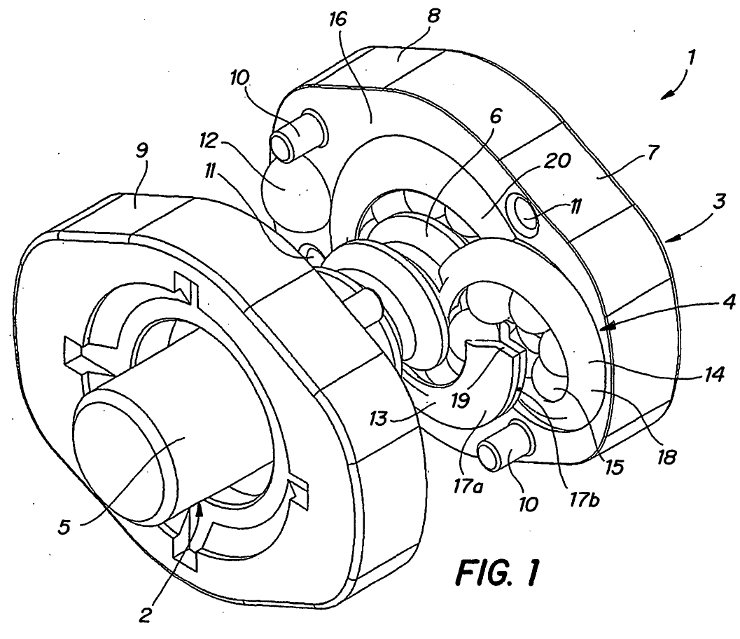

FIG. 1 is a perspective view of a ball screw-nut device according to the invention, the two parts of the housing not being fastened together;

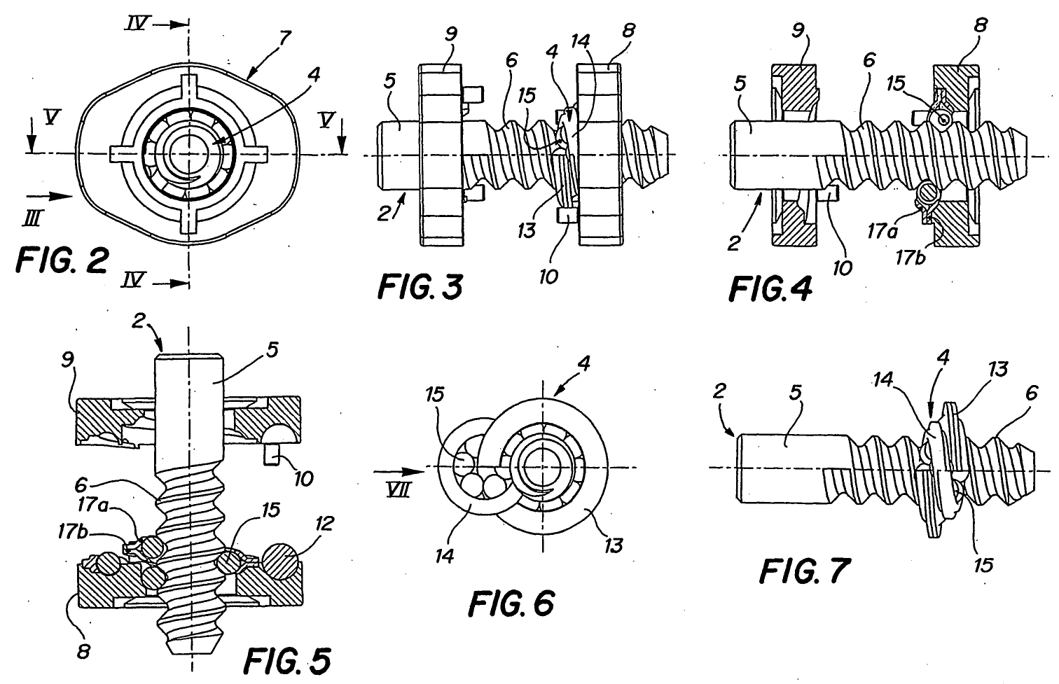

FIG. 2 is a view taken in the direction of an axial end of the ball screw-nut device according to FIG. 1;

FIG. 3 is a view taken in the direction of arrow III of FIG. 2;

FIG. 4 is a cross-sectional view taken along line IV-IV of FIG. 2

FIG. 5 is a cross-sectional view taken along line V-V of FIG. 2

FIG. 6 is a view similar to that of FIG. 2, without the housing of the nut; and

FIG. 7 is a view taken in the direction of arrow VII of FIG. 6.

With reference to the Figures, a screw-nut device 1 with balls includes a screw 2, a nut 3 and balls 15. The screw 2 has a screw axis 5 having a generally cylindrical shape and carrying a thread 6.

The nut 3 includes a housing 7 and a ball bearing device 4. The housing includes, at least, a first housing part 8 and a second housing part 9. In the example illustrated, the housing 7 is made from a plastic material by injection moulding and has a shape which is substantially oblong or elliptic; however, the shape of the housing 7, its dimensions and the material used can be selected according to the specific application considered. Actually, segregating the ball bearing device and, in particular, the ball bearing rail of the same, from the housing of the nut, increases the range of the materials which can be used for making the housing, while ensuring the mechanical resistance and the resistance to wear required for the thread of the nut. For instance, the housing can be made of a plastic material by injection moulding, which is well suited for mass-production even of complex shapes and which, furthermore, makes it possible to reduce the weight and the cost of the device.

The first and the second housing parts 8 and 9 are fastened together through the use of a fastening means which, in the example illustrated, comprises fastening studs 10 designed for being housed into matching stud bores 11. The fastening studs 10 are provided on the facing surfaces of the first and of the second housing parts 8 and 9, with two fastening studs 10 being provided on each part of the housing, on the outer periphery thereof and in such a manner as to be located substantially diametrically opposite one with respect to the other.

A balancing weight 12 provided as a ball 12 is housed in a recess between the housing parts. This weight is selected so as to balance the inertia of the rotating nut. The balancing weight 12 can also act to ensure the proper orientation of the two parts of the housing when assembling the same.

The ball bearing rail 13 has, substantially, the shape of a spire and it includes at least two supporting wall parts 17a, 17b which are substantially identically shaped, thus making it impossible to diminish the number of the different parts which need to be manufactured. Preferably, the supporting wall parts 17a, 17b are formed by a drawing operation from a metal sheet and they can be hardened by a quenching operation, which has the effect of reinforcing the mechanical resistance of these parts against the pressure exerted by the balls 15. Accordingly, these supporting wall parts 17a, 17b can be mass-produced by an automated process and subsequently fastened together, for instance through welding, crimping, riveting or by any other fastening means. The ball bearing rail can also be made as a unitary part in a drawing operation from a metal sheet or by other manufacturing methods, such as forging, injection moulding or machining, without departing from the scope of the invention. The thickness of the supporting wall parts 17a and 17b in certain applications can be relatively small, provided the resistance of the ball bearing rail 13 against the pressure exerted by the balls 15 is sufficient for avoiding a permanent deformation or an excessive wear of the wall parts.

The ball bearing device 4 includes additionally a ball recirculation rail 14 including a supporting wall part 18 having the shape of a spire against which the balls 15 are recirculated from one end 19 to the other end 20 of the ball bearing rail 13. According to an alternate version, the ball recirculation rail 14 can be made of a plastic material. The ball recirculation rail can also be made integrally with the housing 7, in order to diminish the number of pieces, which need to be manufactured. The ball recirculation rail 14 can, advantageously, have the shape of a spire and it can be arranged in relation to the ball bearing rail 13—which also has substantially the shape of a spire—so that the two ball rails 13 and 14 have, in combination, substantially the shape of an “8”, as can best be seen from FIG. 6. The bulk of the nut and, in particular, its thickness in the direction of the axis of rotation A, is particularly small in this construction. This construction of a ball rail shaped as an “8” is also advantageous in the case of a nut in which the ball rail is made integral with the parts of the housing, without departing from the scope of the invention.

The ball bearing device 4 is placed at the interface 16 between the first part 8 of the housing and the second part 9 thereof. This interface is formed by hollowing in a substantially similar manner the first part 8 and the second part 9 of the housing, over a part of their height, from their facing surfaces, i.e. from the surfaces receiving the above-mentioned fastening means. This makes it possible to assemble the ball bearing device with the housing, by means which are simple and can easily be automated.

It is also to be noted, that in the embodiment illustrated, the two parts of the housing are substantially identically shaped, which makes it possible to diminish the number of the different parts which need to be manufactured and, accordingly, to reduce the manufacturing and storage costs.

1. A ball screw-nut device, comprising a screw (2) and a nut (3), the nut comprising a housing (7) and a ball bearing device (4) comprising a ball bearing rail (13) and a plurality of balls (15), the ball bearing device (4) being manufactured as an independent part which is assembled with the housing (7), characterized in that the housing (7) comprises, at least, a first housing part (8) and a second housing part (9) which are fastened together, the ball bearing device (4) being placed at an interface (16) between the two housing parts.

2. A device according to claim 1, characterized in that the first and the second housing parts are identically shaped.

3. A device according to one of the preceding claims, characterized in that the housing (7) is made from a plastic material.

4. A device according to one of the preceding claims, characterized in that the ball bearing rail (13) is formed by a drawing operation from a metal sheet.

5. A device according to one of the preceding claims, characterized in that the ball bearing rail (13) has substantially the shape of a spire.

6. A device according to one of the preceding claims, characterized in that the ball bearing rail (13) is made from at least two supporting wall parts (17a, 17b), which are identically shaped.

7. A device according to one of the preceding claims, characterized in that the device comprises a ball recirculation rail (14), arranged in such a manner as to ensure the recirculation of the balls (15) to the ball bearing rail, the ball recirculation rail (14) having substantially the shape of a spire.

8. A device according to the preceding claim, characterized in that the ball (15) recirculation rail comprises a supporting wall part (18) manufactured separately and assembled with the housing (7).

9. A ball screw-nut device comprising a screw (2) and a nut (3), the nut comprising a housing (7) and a ball bearing device (4) comprising a ball bearing rail (13), a plurality of balls (15) and a ball recirculation rail, characterized in that the ball bearing rail and the ball recirculation rail form together a rail, having substantially the shape of an “8”.

10. A ball screw-nut device according to the preceding claim, characterized in that the ball bearing device (4) is manufactured as an independent part, which is assembled with the housing (7).

11. A device according to claim 9 or claim 10, characterized in that the housing (7) comprises at least a first housing part (8) and a second housing part (9) fastened together, the ball bearing device (4) being placed at an interface (16) between the two housing parts.

12. A device according to the preceding claim, characterized in that the first and the second housing parts are identically shaped.

13. A device according to one of claims 9 to 12, characterized in that the housing (7) is made from a plastic material.

14. A device according to one of claims 9 to 13, characterized in that the ball bearing rail (13) is formed by a drawing operation from a metal sheet.

15. A device according to one of claims 9 to 14, characterized in that the ball bearing rail (13) is made from, at least, two supporting wall parts (17a, 17b) which are both identically shaped.

16. A device according to one of claims 9 to 15, characterized in that the ball (15) recirculation rail comprises a supporting wall part (18) manufactured separately and assembled with the housing (7).
